(19) United States
(12) Patent Application Publication
(10) Pub. No.: US 2022/0404537 A1
(43) Pub. Date: Dec. 22, 2022

(54) ADPATIVE HOLOGRAPHIC PROJECTION SYSTEM WITH USER TRACKING

(71) Applicant: IKIN, Inc., San Diego, CA (US)

(72) Inventor: Taylor Scott GRIFFITH, San Diego, CA (US)

(21) Appl. No.: 17/845,942

(22) Filed: Jun. 21, 2022

Related U.S. Application Data
(60) Provisional application No. 63/213,134, filed on Jun. 21, 2021.

(51) Int. Cl. G02B 5/32; G03H 1/02; G02B 27/14; G06F 3/01; G06F 1/16; G02B 27/01

(52) U.S. Cl. CPC G02B 5/32; G03H 1/0248; G02B 27/142; G02B 27/144; G06F 3/012; G06F 1/1609; G02B 27/0101; G02B 27/0179; G02B 2027/0112; G02B 2027/0187

(57) ABSTRACT

A holographic display system including an electronic device, a camera and a holographic projection unit. The holographic projection unit is configured to generate a volumetric projection for viewing by a user in response to a rendering signal provided by a volumetric display application executing on the electronic device. The holographic projection unit includes a housing, a projector at least partially disposed within the housing and operative to display images based upon the rendering information, and a semi-reflective element being oriented to reflect light from the images in order to create the volumetric projection. The camera is oriented such that the user is within a field of view, the camera being operative to provide the image information to the volumetric display application for determination of a position of the user. The volumetric projection is adapted in response to the position of the user.

### CROSS REFERENCE TO RELATED APPLICATIONS

This application claims the benefit of priority under 35 U.S.C. § 119(e) of U.S. Provisional Application No. 63/213,134, entitled ADPATIVE HOLOGRAPHIC PROJECTION SYSTEM WITH USER TRACKING, filed Jun. 21, 2021. This application is related to U.S. patent application Ser. No. 16/816,154, entitled PORTABLE TERMINAL ACCESSORY DEVICE FOR HOLOGRAPHIC PROJECTION AND USER INTERFACE, filed Mar. 11, 2020 and published Jul. 2, 2020, and to U.S. Patent Application having Attorney Docket No. IKIN-012/01US, entitled EXTERNAL POWER BANK AND COLLAPSIBLE HOLOGRAPHIC PROJECTION ACCESSORY FOR PORTABLE ELECTRONIC DEVICE, filed on even date herewith, the contents of which are incorporated herein in their entirety for all purposes.

### FIELD

The disclosure relates to electronic display systems and, more particularly, to holographic display systems.

### BACKGROUND

Laptop/desktop computers, tablets and other electronic devices are routinely used for audiovisual presentations, often in conjunction with some form of display system. Sophisticated workstations utilized for computer-aided design (CAD) and the like also include electronic displays, often in the form of one or more display monitors incorporating large LCD or OLED screens. However, the screens or monitors in such display systems are generally limited to displaying content in two dimensions.

Virtual Reality (VR) and AR goggle or headset systems have also been created in an attempt to further improve the electronic experience and to at least create the effect of a three-dimensional environment. However, many issues arise for developers of VR and AR systems such as, for example, difficulty of programming, heavy CPU usage, difficulty of manufacture, and the like. The utilization of existing AR and VR systems may also have negative consequences for users. For example, some users of VR and AR equipment experience eye strain, headaches, migraines, nausea, and may be simply generally uncomfortable when using such equipment.

### SUMMARY

Disclosed herein is an adaptive holographic projection system with user tracking. The system includes a holographic projection unit electrically connected to an electronic device such as, for example, a laptop computer, capable of providing a video signal for use by the holographic projection unit. In other implementations the electronic device may be integrated within a housing of the holographic projection unit.

The holographic projection unit includes an external housing, a transparent reflective surface member, and a projector. The projector may be comprised of a Liquid Crystal Display (LCD) screen, Organic Light-Emitting Diode (OLED) screen, image projector or other type of image projection device. In one implementation the transparent reflective surface is comprised of a transparent reflector such as Gorilla glass or the equivalent, with a high-refractive index polymer overlay. The transparent reflective surface will typically be similar or identical in size as the projector (e.g., LCD screen).

The video signal provided by the laptop or other electronic device can be sent via an appropriate cable (e.g., an HDMI, DisplayPort or USB-C cable) operatively connected to the projector, which may be disposed within a housing of the holographic projection unit. The received video signal is translated by the holographic projection unit into a holographic projection. The holographic projection unit provides a portable rendering environment capable of generating relatively large scale holographic projections.

The holographic projection unit may include a camera for providing image information capable of being used to track a viewer's eyes or face in order to enable the holographic rendering to be appropriately adjusted in response to movement in the user's position. More particularly, this tracking of user facial position may be used to elucidate the rendering environment so as to create parallax movement and subsequently generate a genuine sense of depth via the manipulation of the environment.

In one particular aspect the disclosure relates to holographic display system, the display system including an electronic device, a camera and a holographic projection unit. The holographic projection unit is configured to generate a volumetric projection for viewing by a user in response to a rendering signal provided by a volumetric display application executing on the electronic device. The holographic projection unit includes a housing, a projector at least partially disposed within the housing and operative to display images based upon the rendering information, and a semi-reflective element being oriented to reflect light from the images in order to create the volumetric projection. The camera is oriented such that the user is within a field of view, the camera being operative to provide the image information to the volumetric display application for determination of a position of the user. The volumetric projection is adapted in response to the position of the user.

The disclosure also pertains to a holographic projection assembly including a housing having a display bed and defining a camera compartment having an aperture. The aperture is in in alignment with a lens of a camera disposed within the camera compartment. A projector is at least partially disposed within the display bed and is operative to display images based upon a rendering signal. A reflective element is oriented to reflect light from the images in order to create a volumetric projection.

### BRIEF DESCRIPTION OF THE DRAWINGS

For a better understanding of the nature and objects of various embodiments of the invention, reference should be made to the following detailed description taken in conjunction with the accompanying drawings, wherein:

FIG. 1 illustrates an adaptive holographic projection system with user tracking, in accordance with an embodiment.

FIG. 2 is a side perspective view of a holographic display unit included within the projection system of FIG. 1 which illustrates an exemplary orientation of the display unit relative to a viewer.

FIG. 3 is a left side view of the holographic display unit of FIG. 2.

FIG. 4 is a right side view of the holographic display unit of FIG. 2.

FIG. 5 is a front view of the holographic display unit of FIG. 2.

FIG. 6 is a front perspective view of a holographic display unit, according to another embodiment.

FIG. 7 is a side perspective view of the holographic display unit of FIG. 6.

FIG. 8 provides a block diagrammatic view of a holographic projection system in accordance with an embodiment.

FIGS. 9A and 9B are representative of a process for utilizing the holographic projection system of FIG. 8 to create a perceived volumetric animation from a rendering environment.

### DETAILED DESCRIPTION

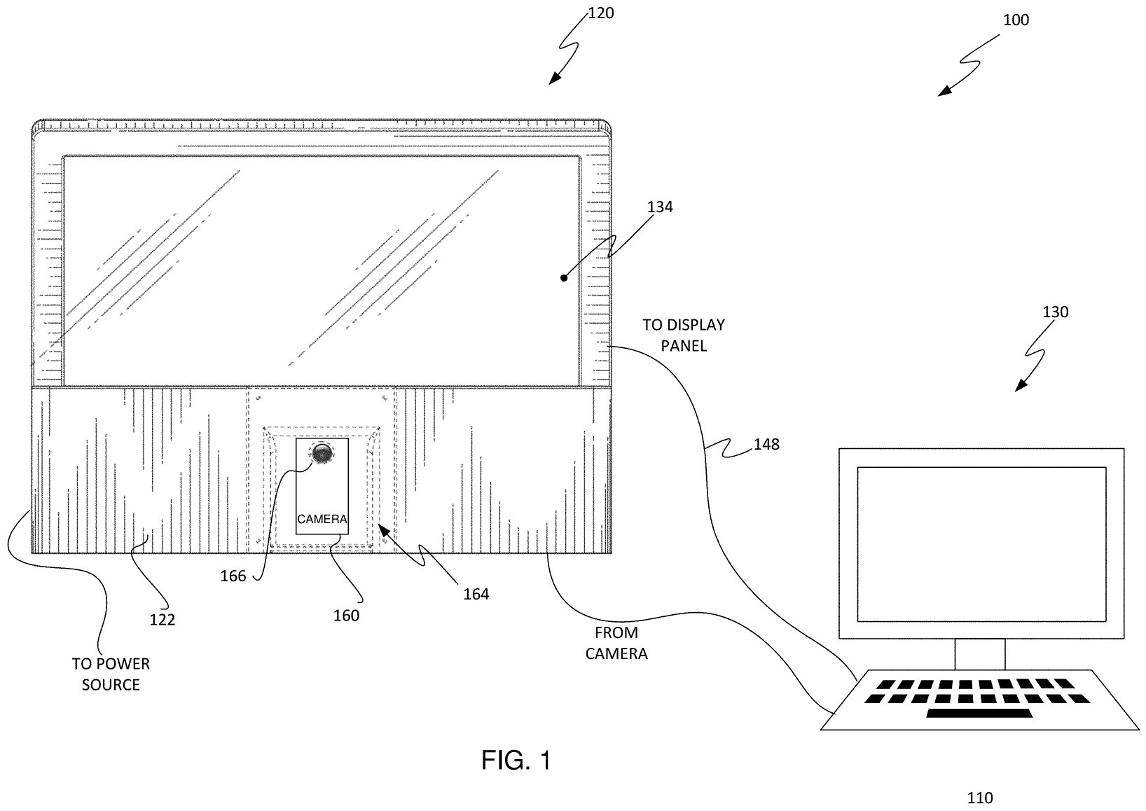

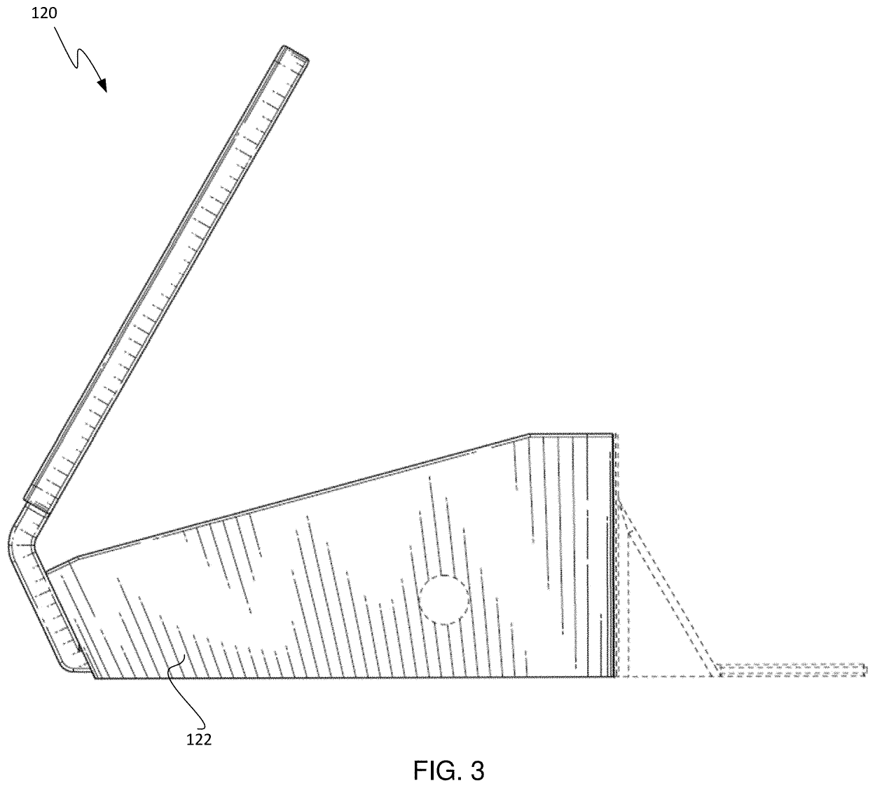

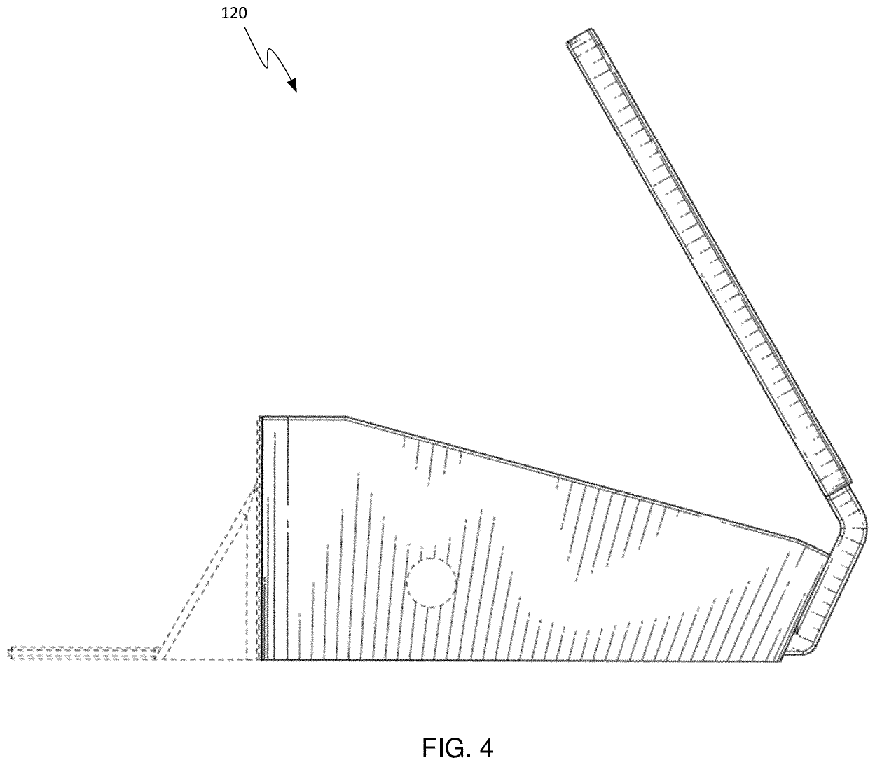

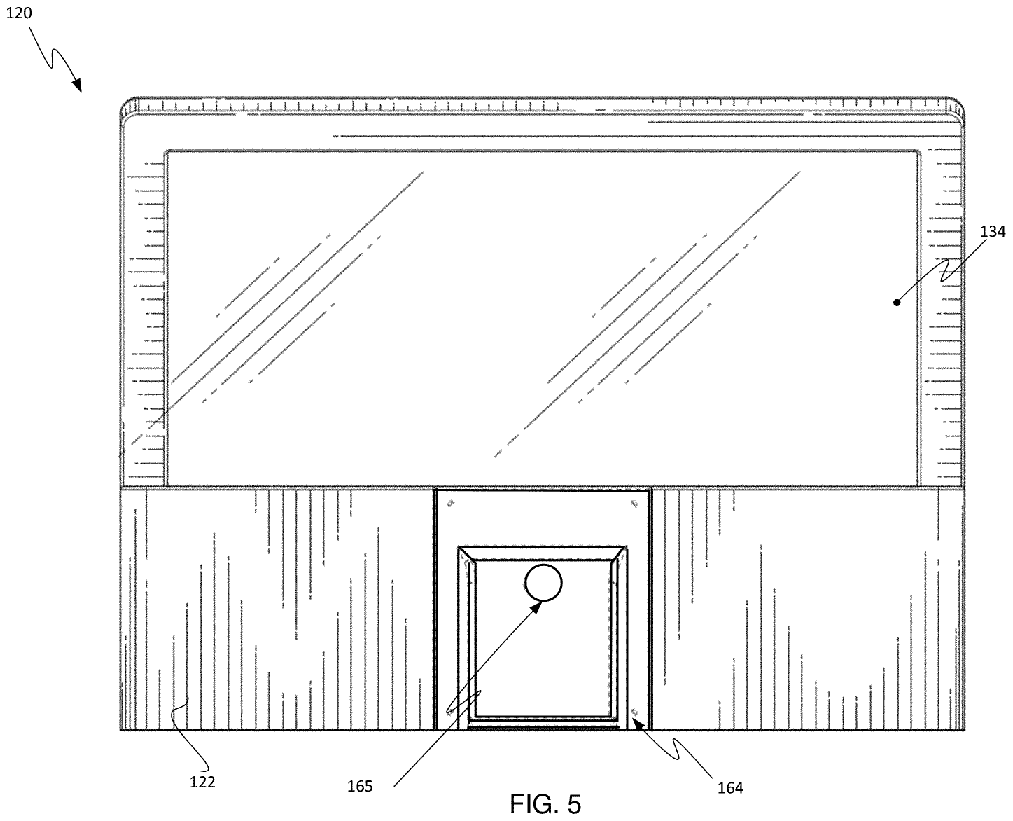

Attention is directed initially to FIGS. 1-5, which illustrate an adaptive holographic projection system with user tracking 100, in accordance with an embodiment. The system 100 includes a holographic projection unit 120 electrically connected to an electronic device 130 such as, for example, a laptop computer. The electronic device 130 provides an image signal, or a video signal or other rendering signal for use by the holographic projection unit 120. In other implementations the electronic device 130 may be integrated within a housing 122 of the holographic projection unit 120.

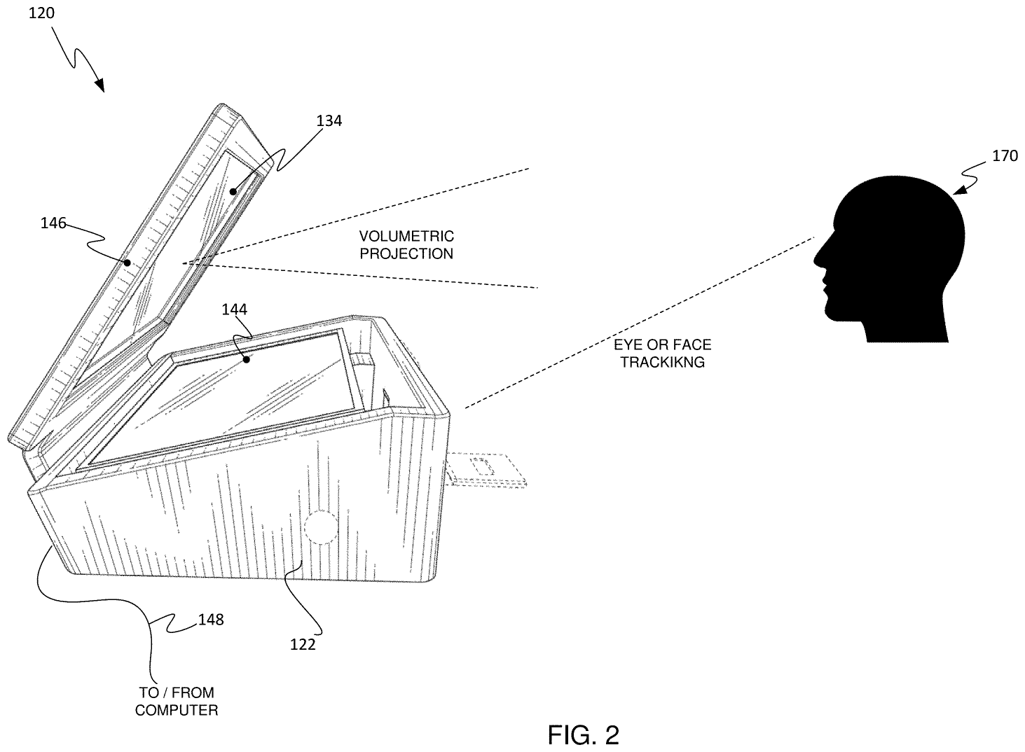

The holographic projection unit 120 further includes a transparent reflective surface 134 and a projector 144. The projector 144 may be comprised of a Liquid Crystal Display (LCD) screen, Organic Light-Emitting Diode (OLED) screen, image projector or other type of image projection device. In one implementation the transparent reflective surface 134 is comprised of a transparent reflector such as Gorilla glass or the equivalent, with a high-refractive index polymer overlay. The transparent reflective surface 134 will typically be similar or identical in size as the projector 144 (e.g., LCD screen). As shown in FIG. 2, the transparent reflective surface 134 is supported by a frame 146 such that a plane of the surface 134 forms a predefined angle with a plane of the projector 144.

The image signal, video signal or other rendering signal provided by the laptop or other electronic device 130 can be sent via an appropriate cable 148 (e.g., an HDMI, DisplayPort or USB-C cable) operatively connected to the projector 144. As shown in FIG. 2, the projector 144 may be disposed within the housing 122 of the holographic projection unit 120. The received signal is used by the holographic projection unit 120 to generate a volumetric projection. The holographic projection unit 120 provides a portable rendering environment capable of generating relatively large scale volumetric projections within a holographic field.

The holographic projection unit 120 may include a camera 160 for providing image information capable of being used to track a viewer's eyes or face in order to enable the holographic rendering to be appropriately adjusted in response to movement in the user's position. The camera 160 may be disposed within a camera compartment 164 (shown in phantom in FIGS. 1, 3 and 4). An aperture 165 defined by a housing of the compartment enables a lens 166 of the camera 160 to have a field of view encompassing a user/viewer 170 of a holographic projection generated by unit 120. In one embodiment image information generated by the camera 160 is provided to the laptop 130, which may use this image information to track a position of the eyes or face of the user/viewer 170. This tracking of the facial or eye position of the user/viewer 170 may be used to elucidate the rendering environment so as to create parallax movement and subsequently generate a genuine sense of depth via the manipulation of the environment.

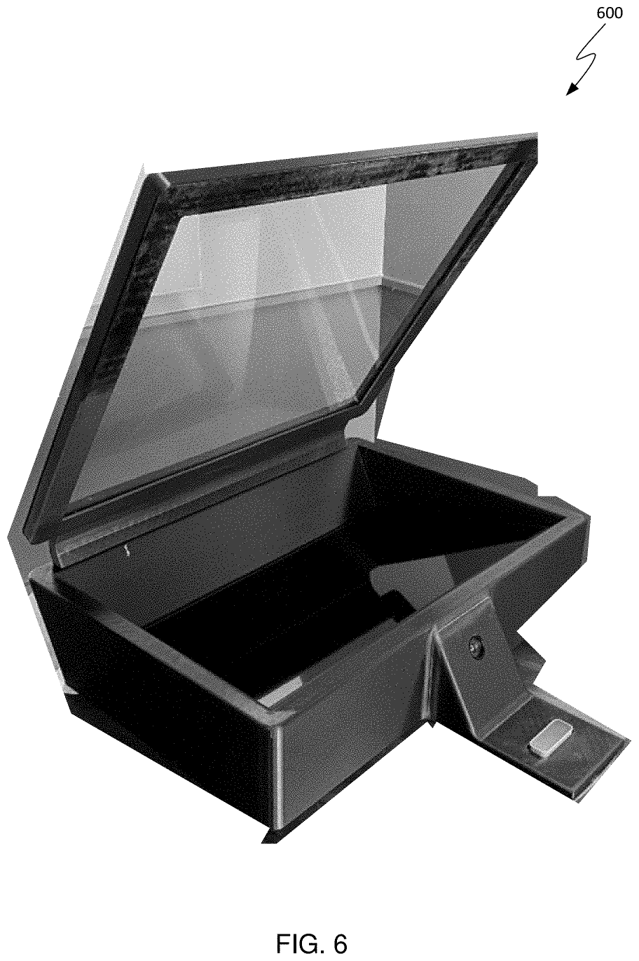

FIG. 6 is a front perspective view of a holographic display unit 600, according to another embodiment.

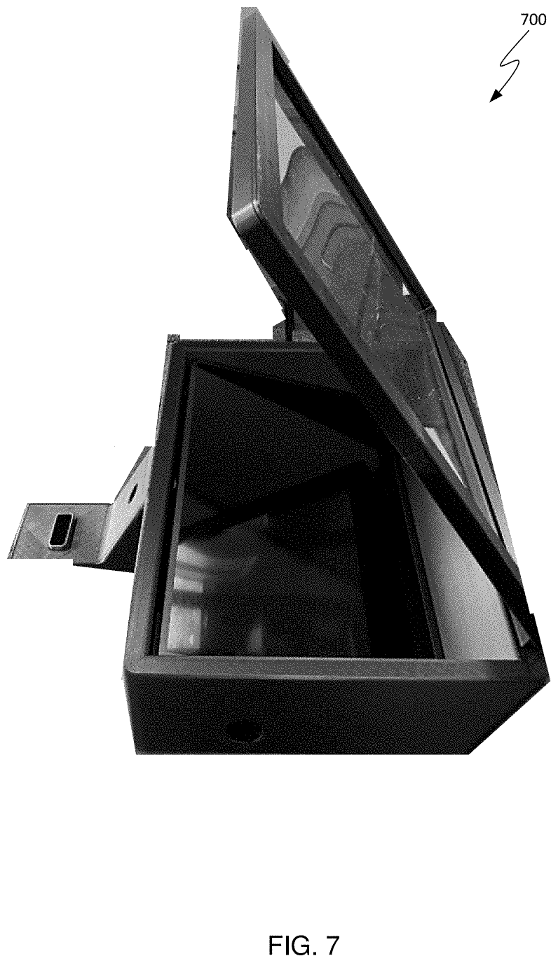

FIG. 7 is a side perspective view of the holographic display unit of 600.

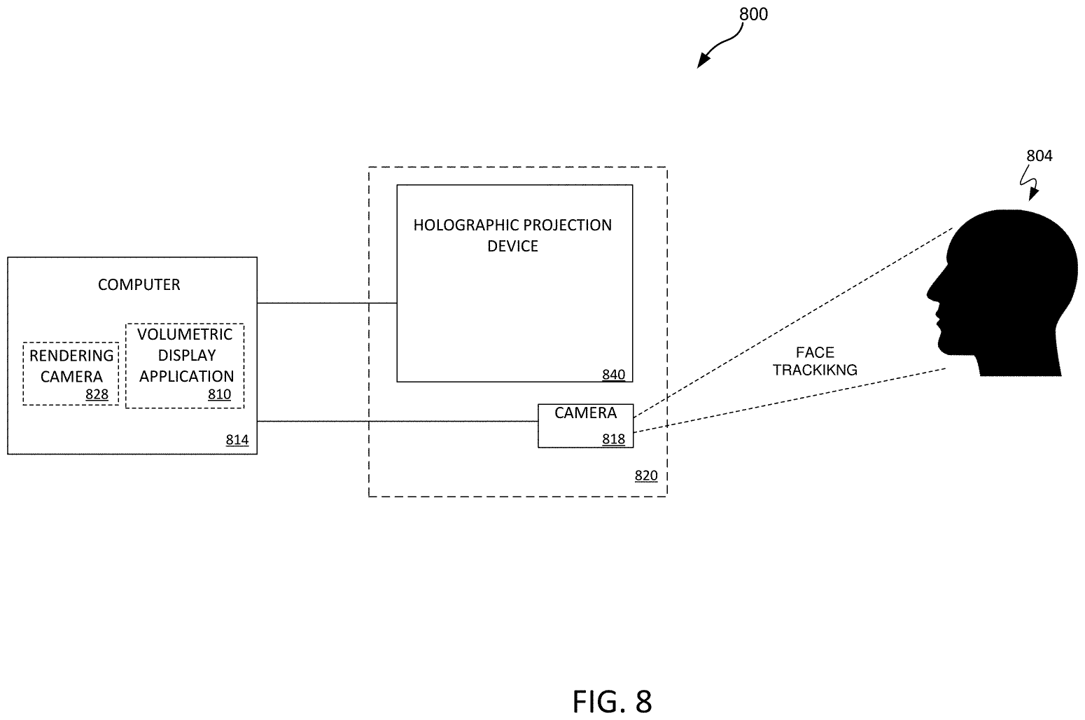

FIG. 8 provides a block diagrammatic view of a holographic projection system 800 in accordance with an embodiment. The system 800 includes a volumetric display application 810 executed by a computer 814, e.g., a laptop computer. The system 800 further includes a holographic projection unit 820 electrically connected to the computer 814. In other implementations the computer 814 may be integrated within a housing 122 of the holographic projection unit 120. The holographic projection unit 820 includes a holographic projection device 840 and a camera 818.

The computer 814 electrically interfaces with the holographic projection device 840 over an electrical connection (e.g., a USB-C connection) so as to enable the computer 814 to provide video and other data to the holographic projection device 840. Such data includes rendering data generated by the volumetric display application 810 and received by the holographic projection unit 840 for volumetric display. During operation, the volumetric display application 810 leverages a rendering camera 828 to create views from specific x,y,z locations within a three-dimensional (3D) space being used by the system 800 in order to facilitate volumetric projection, by the projection device 840, of image or video content stored on or otherwise received by the computer 814. As is discussed below, the camera 818 may be leveraged to track the face of a user 804 and thereby enable corresponding adjustments to be made in the projected volumetric content in a way that enhances the user experience.

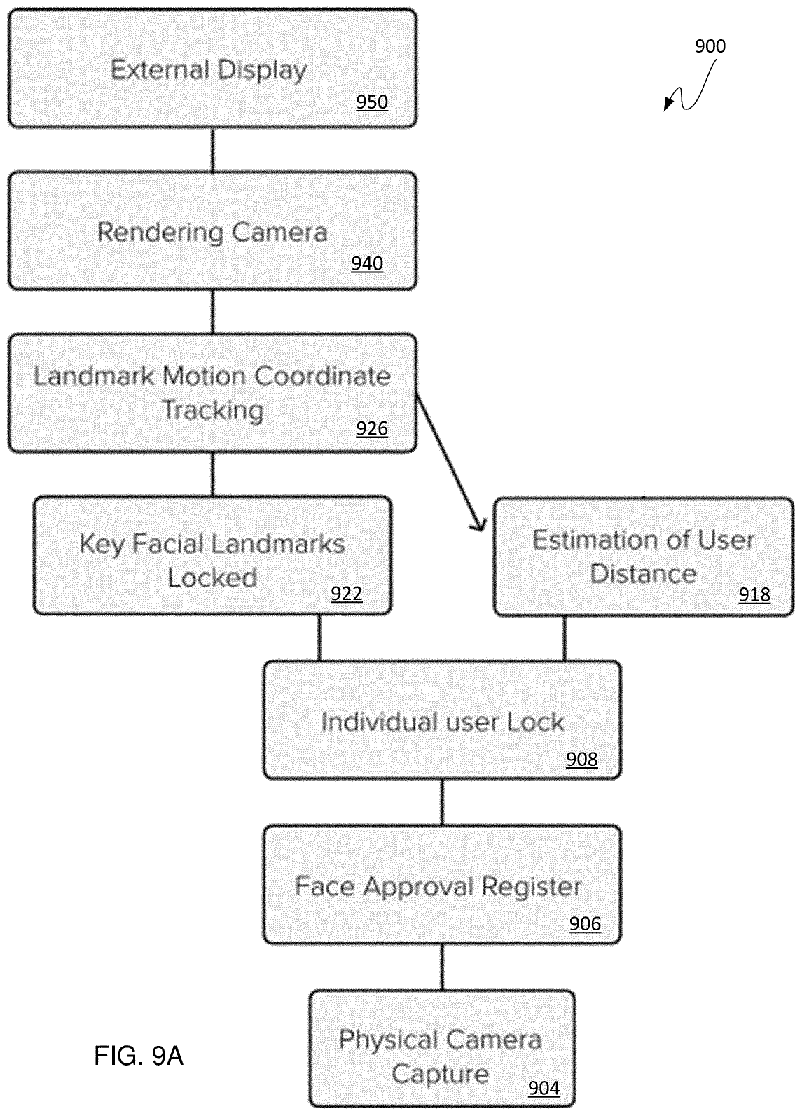

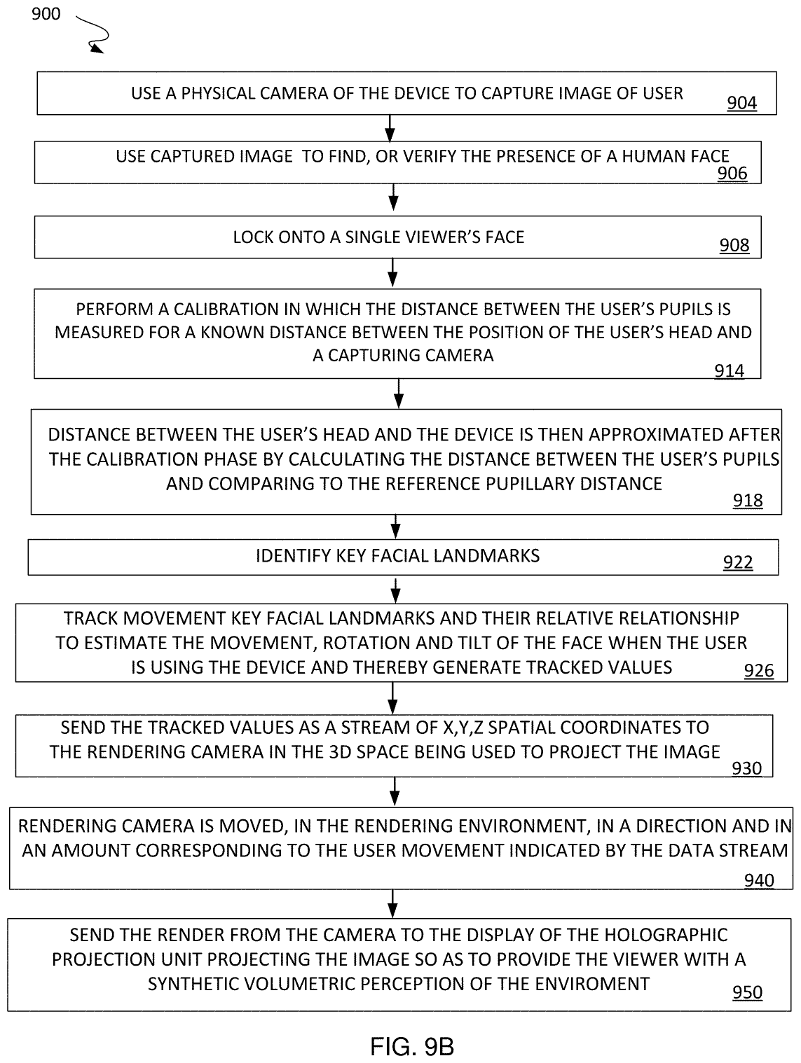

Attention is now directed to FIGS. 9A and 9B, which are representative of a process 900 for utilizing the holographic projection system 800 to create a perceived volumetric animation from a rendering environment. As is discussed below, the process 900 uses using facial tracking coordinated by the volumetric display application 810 to achieve the volumetric animation. FIG. 9A is a diagram illustrating principal stages of the process 900; FIG. 9B provides a flowchart of the process 900.

The process 900 is initiated by using the camera 818 to capture an image containing the user 804 (stage 904). The volumetric display application 810 then uses the captured image to find, or verify the presence of, a human face (stage 906) and to lock on to a single viewer's face, i.e., the face of the user 804 (stage 908). A calibration is performed in which the distance between the pupils of the user 804 is measured for a known distance between the position of the user's head and the camera 818 (stage 914). As the user 804 interacts with the projection system 800, the volumetric display application 810 approximates the distance between the head or face of the user 804 and the camera 818 by calculating the distance between the user's pupils and comparing the calculated distance to the reference pupillary distance determine during the calibration phase (stage 918). Increases in the calculated pupillary distance correspond to relative movement of the face or head of the user 804 away from the camera 818 and decreases in the calculated pupillary distance correspond to head movement toward the camera 818. Key landmarks of the face of the user 804 are then identified by the volumetric display application 810 (stage 922).

Once the key facial landmarks of the user 804 have been identified, the application 810 tracks movement of such landmarks and their relationship in order to estimate the movement, rotation and tilt of the face of the user 804 and thereby track values of the key facial landmarks (stage 926). The tracked values are then sent as a stream of x,y,z spatial coordinates to the rendering camera 828 in the 3D rendering environment being used to project the image (stage 930). The rendering camera 828 is then moved within the rendering environment in a direction and in an amount corresponding the user movement indicated by the stream of x,y,z spatial coordinates (stage 940). The render from the rendering camera 828 is then sent to the display of the holographic projection device 840 so as to provide the user 804 with a synthetic volumetric perception of the environment being rendered by the system 800 (stage 950).

Where methods described above indicate certain events occurring in certain order, the ordering of certain events may be modified. Additionally, certain of the events may be performed concurrently in a parallel process when possible, as well as performed sequentially as described above. Although various modules in the different devices are shown to be located in the processors of the device, they can also be located/stored in the memory of the device (e.g., software modules) and can be accessed and executed by the processors. Accordingly, the specification is intended to embrace all such modifications and variations of the disclosed embodiments that fall within the spirit and scope of the appended claims.

The foregoing description, for purposes of explanation, used specific nomenclature to provide a thorough understanding of the claimed systems and methods. However, it will be apparent to one skilled in the art that specific details are not required in order to practice the systems and methods described herein. Thus, the foregoing descriptions of specific embodiments of the described systems and methods are presented for purposes of illustration and description. They are not intended to be exhaustive or to limit the claims to the precise forms disclosed; obviously, many modifications and variations are possible in view of the above teachings. The embodiments were chosen and described in order to best explain the principles of the described systems and methods and their practical applications, they thereby enable others skilled in the art to best utilize the described systems and methods and various embodiments with various modifications as are suited to the particular use contemplated. It is intended that the following claims and their equivalents define the scope of the systems and methods described herein.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded into one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A holographic display system, the display system comprising:
an electronic device;
a camera; and
a holographic projection unit configured to generate a volumetric projection for viewing by a user in response to a rendering signal provided by a volumetric display application executing on the electronic device, the holographic projection unit including a housing, a projector at least partially disposed within the housing and operative to display images based upon the rendering information, and a semi-reflective element being oriented to reflect light from the images in order to create the volumetric projection;
wherein the camera is oriented such that the user is within a field of view, the camera being operative to provide the image information to the volumetric display application for determination of a position of the user;
wherein the volumetric projection is adapted in response to the position of the user.

2. The holographic display system of claim 1 wherein the semi-reflective element includes a transparent reflector coated with a polymer overlay.

3. The holographic display system of claim 1 wherein the projector includes a screen of a first size and wherein the semi-reflective element is of a second size, the first size being substantially identical to the second size.

4. The holographic display system of claim 1 wherein the housing has a display bed and defines a camera compartment having an aperture to be in alignment with a lens of the camera wherein the camera is disposed within the camera compartment.

5. The holographic display system of claim 4 wherein the projector is at least partially disposed within the display bed.

6. A holographic projection assembly, comprising:
a housing having a display bed and defining a camera compartment having an aperture, the aperture being in alignment with a lens of a camera disposed within the camera compartment;
a projector at least partially disposed within the display bed and operative to display images based upon a rendering signal;
a reflective element being oriented to reflect light from the images in order to create a volumetric projection.

7. The holographic projection assembly of claim 6 wherein the reflective element includes a transparent reflector coated with a polymer overlay.

8. The holographic projection assembly of claim 6 wherein the projector includes a screen of a first size and wherein the reflective element is of a second size, the first size being substantially identical to the second size.

9. The holographic projection assembly of claim 6 further including an electronic device executing a volumetric display application configured to generate the rendering signal.
